(19) United States
(12) Patent Application Publication
(10) Pub. No.: US 2025/0011088 A1
(43) Pub. Date: Jan. 9, 2025

(54) SYSTEM FOR MANAGING PHARMACEUTICAL STOCK WAREHOUSE

(71) Applicant: NORIAND CO.,LTD., Seoul (KR)

(72) Inventor: Hyejin LEE, Gyeonggi-do (KR)

(21) Appl. No.: 18/225,168

(22) Filed: Jul. 24, 2023

(30) Foreign Application Priority Data
Jul. 4, 2023 (KR) 10-2023-0086696

(51) Int. Cl. B65G 1/137; G05B 15/02; G06Q 10/0833; G06Q 10/087

(52) U.S. Cl. CPC B65G 1/1373; G05B 15/02; G06Q 10/0833; G06Q 10/087; G06Q 10/08355; G08B 7/00

(57) ABSTRACT

Disclosed is a pharmaceutical stock warehouse management system. The pharmaceutical stock warehouse management system may include: a plurality of event notification units; a user terminal for recognizing product information under control of a user; and a server performing at least one operation for controlling the plurality of event notification units based on the product information received from the user terminal.

### CROSS-REFERENCE TO RELATED APPLICATION

This application claims priority to and the benefit of Korean Patent Application No. 10-2023-0086696 filed in the Korean Intellectual Property Office on Jul. 4, 2023, the entire contents of which are incorporated herein by reference.

### BACKGROUND

### Technical Field

The present invention relates to a pharmaceutical warehouse management system for article distribution applied to a distribution center, and more particularly, to a warehouse management system for distributing pharmaceutical stock articles.

### Background Art

In general, a pharmaceutical warehouse may be a place where large quantities of products are enclosed in packaging, such as boxes, and stored. Tens of thousands of products may be moved in and out of a warehouse, even in a single day.

In particular, a medicine is sensitive to expiration dates and external shocks, so appropriate logistics management is required.

Managers are required to have a technique of recognizing the types and numbers of products that have been moved into and out of the warehouse in detail and accurately. In addition, managers should also consider the space available for additional products in the warehouse and know the locations at which the products are stacked.

However, in recent years, due to the development of the parcel service system, a large number of products are brought in and out every day, and managers may have difficulty in managing products. In addition, managers need to guide the location where the products are stored to workers and instruct the workers to move or retrieve the products, but it is difficult to give clear instructions for products that change location several times a day.

On the other hand, Radio Frequency IDentification (RFID) is a technology that stores information about products or objects in electronic tags and recognizes the information by using radio waves. Unlike barcodes, which read information by touching a reader to an object, RFID sends and receives signals wirelessly, so RFID has longer recognition distance compared to barcodes and enables users to recognize information of several products at the same time, thereby achieving advantages in fast recognition speed and connection to other communication networks. RFID devices may be used to provide information and the like for managing products in a warehouse.

### SUMMARY

The present invention has been made in an effort to provide a pharmaceutical warehouse management system for easily managing products stored in a warehouse.

The technical objects of the present disclosure are not limited to the foregoing technical objects, and other non-mentioned technical objects will be clearly understood by those skilled in the art from the description below.

An exemplary embodiment of the present invention provides a warehouse management system, including: a plurality of event notification units; a user terminal for recognizing product information under control of a user; and a server performing at least one operation for controlling the plurality of event notification units based on the product information received from the user terminal.

The at least one operation may include at least one of: a first operation of controlling the plurality of event notification units to cause a first event notification unit present at a first location where a product corresponding to the product information is stored to emit light; a second operation of controlling the plurality of event notification units to cause a second event notification unit present at a second location where a product corresponding to the product information is stored to emit a sound; and a third operation of controlling the plurality of event notification units to cause a third event notification unit present at a third location where a product corresponding to the product information is stored to emit light and a sound.

The server may receive location information indicative of a location of the user terminal in conjunction with reception of the product information from the user terminal, and the at least one operation may include at least one of: a fourth operation of controlling, based on the location information of the user terminal, at least one fourth event notification unit present along a route from the location of the user terminal to a fourth location where a product corresponding to the product information are stored to emit light; and a fifth operation of controlling, based on the location information of the user terminal, the plurality of event notification units such that a sound emitted by a fifth event notification unit present at a fifth location becomes louder as the location of the user terminal approaches the fifth location where a product corresponding to the product information are stored.

The server may receive location information indicative of a location of the user terminal in conjunction with reception of the product information from the user terminal, and the at least one operation may include a sixth operation of providing, based on the location information of the user terminal, a route to the user terminal such that a route from a location of the user terminal to a sixth location at which a product corresponding to the product information is stored is displayed on the user terminal.

The warehouse management system may further include a pallet on which at least one product is stacked, in which the pallet may include: a sensing unit for sensing weight of the at least one product; and a pallet control unit for, when a change in weight sensed by the sensing unit is detected, transmitting information about the change in weight to the server through a pallet communication unit.

The technical solutions obtainable from the present disclosure are not limited to the foregoing solutions, and other non-mentioned solution means will be clearly understood by those skilled in the art from the description below.

In accordance with some exemplary embodiments of the present disclosure, it is possible to provide a warehouse management system that allows a user to conveniently check locations where products are stacked.

The effects of the present disclosure are not limited to the foregoing effects, and other non-mentioned effects will be clearly understood by those skilled in the art from the description below.

### BRIEF DESCRIPTION OF THE DRAWINGS

Various aspects are described with reference to the drawings, and herein, like reference numerals are generally used to designate like constituent elements. In the exemplary embodiment below, for the purpose of description, a plurality of specific and detailed matters is suggested in order to provide general understanding of one or more aspects. However, it is apparent that the aspect(s) may be carried out without the specific and detailed matters. In other examples, well-known structures and devices are illustrated in a block diagram in order to facilitate describing one or more aspects.

FIG. 1 is an exemplary block diagram for implementing a warehouse management system according to some exemplary embodiments of the present disclosure.

FIG. 2 is a diagram illustrating an example of a warehouse management system according to some exemplary embodiments of the disclosure.

FIG. 3 is a diagram to illustrate an example of a warehouse management system according to some exemplary embodiments of the disclosure.

FIG. 4 is a drawing illustrating an example of a pallet according to some exemplary embodiments of the present disclosure.

FIG. 5 is a diagram illustrating an example of distribution of individual products in the warehouse management system according to some exemplary embodiments of the present disclosure.

### DETAILED DESCRIPTION

The invention is subject to various modifications and may have many exemplary embodiments, and certain exemplary embodiments are illustrated in the drawings and described in more detail in the detailed description. However, it is not intended to limit the present invention to the specific exemplary embodiments, and it will be appreciated that the present invention includes all modifications, equivalences, or substitutions included in the spirit and the technical scope of the present invention. In describing each drawing, like reference numerals in the drawings refer to the same or similar functions.

Terms including an ordinary number, such as first, second, A, and B, are used for describing various constituent elements, but the constituent elements are not limited by the terms. The terms are used only to discriminate one constituent element from another constituent element. For example, without departing from the scope of the invention, a first constituent element may be named as a second constituent element, and similarly a second constituent element may be named as a first constituent element. A term “and/or” includes a combination of multiple relevant described items or any one of the multiple relevant described items.

It should be understood that when one constituent element referred to as being “coupled to” or “connected to” another constituent element, one constituent element can be directly coupled to or connected to the other constituent element, but intervening elements may also be present. By contrast, when one constituent element is referred to as being “directly coupled to” or “directly connected to” another constituent element, it should be understood that there are no intervening elements.

Terms used in the present application are used only to describe specific exemplary embodiments, and are not intended to limit the present invention. Singular expressions used herein include plurals expressions unless they have definitely opposite meanings in the context. In the present specification, it should be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

All terms used herein including technical or scientific terms have the same meanings as meanings which are generally understood by those skilled in the art unless they are differently defined. Terms defined in generally used dictionary shall be construed that they have meanings matching those in the context of a related art, and shall not be construed in ideal or excessively formal meanings unless they are clearly defined in the present application.

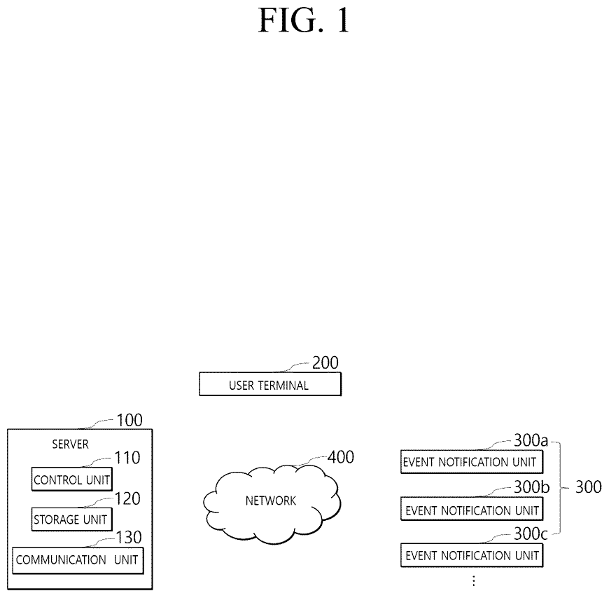

In the present disclosure, a warehouse management system may include a server. The server may store, based on information received from a user terminal, locations, stock, the number, and date of storage and release of products stored in the warehouse. The server may also provide guidance to a user to indicate the location of the product based on information received via a user terminal, such as a Radio Frequency Identification (RFID) device. For example, a user may control an event notifying unit, such as a light or a speaker, to provide guidance to the user to indicate the location of the product. Hereinafter, a warehouse management system according to the present disclosure will be described with reference to FIGS. 1 to 4.

FIG. 1 is an exemplary block diagram for a warehouse management system according to some exemplary embodiments of the present disclosure.

Referring to FIG. 1, a server 100 may include a control unit 110, a storage unit 120, and a communication unit 130. However, since the above-described constituent elements are not essential in implementing the server 100, the server 100 may have more or fewer components than those listed above.

The server 100 may include any type of computer system or computer device, such as, for example, a microprocessor, a mainframe computer, a digital processor, a portable device, or a device controller.

The server 100 may achieve desired system performance by using a combination of typical computer hardware (for example, devices that may include computer processors, memory, storage, input devices and output devices, and other components of existing computing devices; electronic communications devices, such as routers and switches; and electronic information storage systems, such as Network-Attached Storage (NAS) and Storage Area Networks (SAN))) and computer software (that is, instructions that cause a computing device to function in a particular way).

The control unit 110 may generally handle the overall operation of the server 100. The control unit 110 may process signals, data, information, and the like that are input to or output from components of the server 100, or may run application programs stored in the storage unit 120, to provide a user with or process appropriate information or function.

The control unit 110 may include one or more cores and may include processors for data analysis, such as a Central Processing Unit (CPU), a General Purpose Graphics Processing Unit (GPGPU), and a Tensor Processing Unit (TPU).

In the present disclosure, the control unit 110 may control a plurality of event notification units 300 to perform at least one operation.

For example, the communication unit 130 may receive product information from a user terminal 200. The control unit 110 may control the plurality of event notification units 300 such that a first event notification unit present at a first location where a product corresponding to the product information is stored emits light.

In another example, the control unit 110 may control the plurality of event notification units 300 such that a second event notification unit present at a second location where a product corresponding to the product information is stored emits a sound.

Hereinafter, an example of a method of performing, by the control unit 110, at least one operation to control the plurality of event notification units will be described below.

The storage unit 120 may include a memory and/or a persistent storage medium. The memory may include at least one type of storage medium among a flash memory type, a hard disk type, a multimedia card micro type, a card type of memory (for example, an SD or XD memory), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, and an optical disk.

In the present disclosure, the storage unit 120 may have a database of product management information about the locations of products stored in the warehouse, the number of products, the date the products were brought in and out, the date the products are to be brought in and out, the weight of the products, or the volume of the products.

The communication unit 130 may include one or more modules that enable communication between the server 100 and a communication system, between the server 100 and the user terminal 200, between the server 100 and the plurality of event notification units 300, or between the server 100 and a network 400.

The user terminal 200 may achieve desired system performance by using a combination of typical computer hardware (for example, devices that may include computer processors, memory, storage, input devices and output devices, and other components of existing computing devices; electronic communications devices, such as routers and switches; and electronic information storage systems, such as Network-Attached Storage (NAS) and Storage Area Networks (SAN))) and computer software (that is, instructions that cause a computing device to function in a particular way). The first user terminal 200 may include a personal computer (PC), a notebook computer, a mobile terminal, a smart phone, a tablet PC, and an RFID device owned by the user, and may include any kind of terminal that can access a wired or wireless network. In one example, the user terminal 200 may be a Point Of Production (POP) utilized in a logistics system.

In the present disclosure, the user terminal 200 may recognize product information under control of the user. For example, the user terminal 200 may receive input from the user to select the at least one product. The user terminal 200 may determine a product-related code indicative of at least one product, or may receive input of code information. Then, the user terminal 200 may transmit product information including the product-related code to the server 100.

The network 400 may be a closed network, such as a Local Area Network (LAN) and a Wide Area Network (WAN), or an open network, such as the Internet. The Internet refers to a worldwide and open computer network structure that provides the TCP/IP protocol and a number of services on top of the TCP/IP protocol, that is, Hyper Text Transfer Protocol (HTTP), Telnet, File Transfer Protocol (FTP), Domain Name System (DNS), Simple Mail Transfer Protocol (SMTP), Simple Network Management Protocol (SNMP), Network File Service (NFS), and Network Information Service (NIS).

The plurality of event notification units 300 may be lights, speakers, or the like. The plurality of event notification units 300 may be provided to a pallet on which the products are stacked, on a structure above the location where the products are stacked, on the ceiling of the location where the products are stacked, or on the floor of the location where the products are stacked.

The plurality of event notification units 300 may perform at least one operation under control from the server 100.

Specifically, the control unit 110 may perform at least one operation to control the plurality of event notification units based on product information received from the user terminal 200.

At least one operation may include a first operation of controlling the plurality of event notification units 300 to cause a first event notification unit present at the first location where the product corresponding to the product information is stored to emit light.

Specifically, when the product information is received from the user terminal 200, the control unit 110 may determine a first product corresponding to the product information based on a product-related code included in the product information. The control unit 110 may determine the first location within the warehouse where the first product is stored based on the database existing in the storage unit 120. The control unit 110 may determine the first event notification unit present at the location corresponding to the first location. The control unit 110 may control the plurality of event notification units 300 such that the determined first event notification unit emits light. Herein, the control of the plurality of event notification units 300 may be understood as the meaning of controlling the first event notification unit 300 to emit light, and controlling other event notification units other than the first event notification unit 300 not to emit light.

For example, the control unit 110 may determine a first-one event notification unit attached to a pallet on which the first product is stacked, a first-two event notification unit present above the first location, a first-three event notification unit present on the ceiling of the first location, a first-four event notification unit present on the floor of the first location, and the like. The control unit 110 may control the plurality of event notification units 300 such that at least one of the determined first-one event notification unit to the first-four event notification unit emits light.

At least one operation may include a second operation of controlling the plurality of event notification units 300 such that the second event notification unit present at the second location where the product corresponding to the product information is stored to emit a sound.

Specifically, when the product information is received from the user terminal 200, the control unit 110 may determine a second product corresponding to the product information based on a product-related code included in the product information. The control unit 110 may determine the second location within the warehouse where the second product is stored based on the database existing in the storage unit 120. The control unit 110 may determine the second event notification unit present at the location corresponding to the second location. The control unit 110 may control the plurality of event notification units 300 such that the determined second event notification unit emits a sound.

For example, the control unit 110 may determine a second-one event notification unit attached to a pallet on which the second product is stacked, a second-two event notification unit present above the second location, a second-three event notification unit present on the ceiling of the second location, a second-four event notification unit present on the floor of the second location, and the like. The control unit 110 may control the plurality of event notification units 300 such that at least one of the determined second-one event notification unit to the second-four event notification unit emits a sound.

At least one operation may include a third operation of controlling the plurality of event notification units 300 such that the third event notification unit present at the third location where the product corresponding to the product information is stored to emit light and a sound.

Specifically, when the product information is received from the user terminal 200, the control unit 110 may determine a third product corresponding to the product information based on a product-related code included in the product information. The control unit 110 may determine the third location within the warehouse where the third product is stored based on the database existing in the storage unit 120. The control unit 110 may determine the third event notification unit present at the location corresponding to the third location. The control unit 110 may control the plurality of event notification units 300 such that the determined third event notification unit emits light and a sound.

For example, the control unit 110 may determine a third-one event notification unit attached to a pallet on which the third product is stacked, a third-two event notification unit present above the third location, a third-three event notification unit present on the ceiling of the third location, a third-four event notification unit present on the floor of the third location, and the like. The control unit 110 may control the plurality of event notification units 300 such that at least one of the determined third-one event notification unit to the third-four event notification unit emits light and a sound.

According to some exemplary embodiments of the present disclosure, the communication unit 130 may receive location information indicative of the location of the user terminal 200 in conjunction with reception of the product information from the user terminal 200.

In this case, at least one operation may include a fourth operation of controlling, based on the location information of the user terminal 200, at least one fourth event notification unit present along a route from the location of the user terminal 200 to a fourth location where the product corresponding to the product information is stored to emit light.

Specifically, when the product information is received from the user terminal 200, the control unit 110 may determine a fourth product corresponding to the product information based on a product-related code included in the product information. The control unit 110 may determine the fourth location within the warehouse where the fourth product is stored based on the database existing in the storage unit 120. The control unit 110 may determine at least one fourth event notification unit present along a route from the location of the user terminal 200 to the fourth location where the fourth product is stored. The control unit 110 may control the plurality of event notification units 300 such that the determined at least one fourth event notification unit emits light.

According to some exemplary embodiments of the present disclosure, the control unit 110 may receive a plurality of product information from the user terminal 200. For example, the control unit 110 may receive fourth-1 product information associated with the fourth-1 product and fourth-2 product information associated with the fourth-2 product. Based on the database existing in the storage unit 120, the control unit 110 may determine a fourth-1 location in the warehouse where the fourth-1 product is stored, a fourth-2 location in the warehouse where the fourth-2 product is stored, and a location of the user terminal 200. The control unit 110 may determine an optimal route for the user to obtain the fourth-1 product and the fourth-2 product.

For example, the fourth-2 product may exist between the current location of the user terminal 200 and the fourth-1 location of the fourth-1 product. In this case, the control unit 110 may provide a route for the user to obtain the fourth-1 product after obtaining the fourth-2 product.

For example, the control unit 110 may determine at least one fourth-2 event notification unit that exists along a route from the location of the user terminal 200 to the fourth-2 location where the fourth-2 product is stored. The control unit 110 may control the plurality of event notification units 300 such that the determined at least one fourth-2 event notification unit emits light. Further, the control unit 110 may determine the at least one fourth-1 event notification unit present along the route from the fourth-2 location to the fourth-1 location where the fourth-1 product is stored. The control unit 110 may control the plurality of event notification units 300 such that the determined at least one fourth-1 event notification unit emits light.

According to the exemplary embodiment, when the control unit 110 receives a plurality of product information from the user terminal 200, the control unit 110 may determine an optimal route for releasing the product, and control the event notification unit 300 in turn to correspond to the route. For example, the control unit 110 may determine an optimal route for the user to move to take the shortest route in the process of releasing a plurality of products, and perform control over the event notification unit 300 such that the event notification unit 300 operates in turn to correspond to the determined route. In another example, the control unit 110 may control the event notification unit 300 in consideration of the order in which the plurality of products is delivered to the delivery location in the process of generating the shortest route. More specifically, when a plurality of products is each delivered to a separate delivery location, the control unit 110 may generate an optimal route so that in the order of the delivery of each product, the product to be first stacked onto the delivery vehicle is released later and stacked on the pallet, and control the event notification unit 300 to correspond to the generated optimal route. In addition, when the plurality of products is released and stacked onto the pallet one after another, there is a risk of damage to the products if the products having weight equal to or greater than predetermined weight are stacked on top of lighter products or more fragile products. In consideration of this, the control unit 110 may set a route so that products having weight equal to or greater than predetermined weight are preferentially released in the process in which the products released one after another along the set route are stacked on the pallet and control the event notification unit 300 to correspond to the route. In addition, the control unit 110 may also set a route in consideration of products that adversely affect each other when placed adjacent to each other. For example, the control unit 110 may set a route so that products that need to be maintained at a relatively cool temperature and products that need to be maintained at a temperature above room temperature are not located in adjacent locations on the pallet during the releasing process, and control the event notification unit 300 to correspond to the route. In addition, when there is a magnetic body within a certain distance, the control unit 110 may set a route so that malfunctionable products and magnetic products are placed on the pallet over a predetermined distance, and control the event notification unit 300 to correspond to the route.

The control unit 110 may determine an optimal route based on structure information of a cargo area of a vehicle in which the products to be released are stacked, structure information of each of the products to be released, and delivery destination information of the products, and control the event notification unit 300 according to the optimal route. For example, based on the fact that different vehicles may have different structures in the cargo area and structure information of each of the products may be different, the control unit 110 may set a route such that the products that are stacked onto the vehicle first are preferentially released, and determine an order in which the products are released so that the products are stacked in the most efficient manner (that is, so that the most products can be reliably stacked) based on the structure of the cargo area of the vehicle and the structures of the products when the products to be released are stacked into the vehicle, and perform a series of controls to cause the event notification unit 300 to operate based on the determined order.

In the aforementioned route setting process of the control unit 110, when the products are stacked on the pallet in turn, and when the intended purpose cannot be achieved, the control unit 110 sets a predetermined area of the pallet in advance, and provides a notification so that specific products are separately placed in a predetermined area through the event notification unit 300 corresponding to the specific products in the situation where the products are released according to the set route, to support the placement of products to achieve the aforementioned purposes.

At least one operation may include a fifth operation of controlling the plurality of event notification units 300 such that, based on location information of the user terminal 200, a sound emitted by a fifth event notification unit present at a fifth location becomes louder as the location of the user terminal 200 approaches the fifth location where a product corresponding to the product information is stored.

Specifically, when the product information is received from the user terminal 200, the control unit 110 may determine a fifth product corresponding to the product information based on a product-related code included in the product information. The control unit 110 may determine the fifth location within the warehouse where the fifth product is stored based on the database existing in the storage unit 120. The control unit 110 may determine the fifth event notification unit present at the location corresponding to the fifth location. The control unit 110 may receive location information from the user terminal 200 based on a change in location. The control unit 110 may control the plurality of event notification units 300 such that the sound emitted by the fifth event notification unit becomes louder as the location of the user terminal 200 approaches the fifth location.

According to the exemplary embodiment, the control unit 110 may transmit a control signal to the user terminal 200 to cause sound to be emitted from the user terminal 200. In this case, the user terminal 200 may be controlled such that the sound becomes louder as the location of the user terminal 200 approaches the fifth location.

According to one exemplary embodiment, the user terminal 200 may include a display unit capable of providing a map or the like. In this case, based on the location information received from the user terminal 200, the control unit 110 may provide a route to the user terminal 200 such that a route from the location of the user terminal 200 to a sixth location where the products corresponding to the product information are stored is displayed on the user terminal 200.

Specifically, when the product information is received from the user terminal 200, the control unit 110 may determine a sixth product corresponding to the product information based on a product-related code included in the product information. The control unit 110 may determine the sixth location within the warehouse where the sixth product is stored based on the database existing in the storage unit 120. The control unit 110 may generate route information from the location of the user terminal 200 to the sixth location where the sixth product is stored. The control unit 110 may transmit the route information to the user terminal 200 through the communication unit 130, thereby causing the route to be displayed on the display unit of the user terminal 200.

According to some exemplary embodiments of the present disclosure, the control unit 110 may receive a plurality of product information from the user terminal 200. For example, the control unit 110 may receive sixth-1 product information associated with the sixth-1 product and sixth-2 product information associated with the sixth-2 product. Based on the database existing in the storage unit 120, the control unit 110 may determine a sixth-1 location in the warehouse where the sixth-1 product is stored, a sixth-2 location in the warehouse where the sixth-2 product is stored, and a location of the user terminal 200. The control unit 110 may generate route information for the user to obtain the sixth-1 product and the sixth-2 product. Then, the control unit 110 may transmit the route information to the user terminal 200 through the communication unit 130, thereby causing the route to be displayed on the display unit of the user terminal 200.

The warehouse management system may further include a pallet on which the at least one product is stacked.

A pallet according to the present disclosure may include a sensing unit, a pallet communication unit, and a pallet control unit.

The sensing unit may sense the weight of at least one product stacked on the pallet.

When a change in the weight sensed by the sensing unit is detected, the pallet control unit may transmit information about the weight change to the server 100 through the pallet communication unit.

According to the exemplary embodiment, the control unit 110 of the server 100 having received information about the weight change from the pallet may manage the stock of the products based on the information about the weight change.

For example, the storage unit 120 may have a database of product management information about the number of products, the date the products were brought in and out, the date the products are to be brought in and out, the weight of the products, or the volume of the products. When the control unit 110 receives information about the weight change from the pallet, the control unit 110 may determine whether the product has been released or whether a product has been additionally stacked based on the changed weight change.

Based on the weight information and the volume information for each product stored in the storage unit 120, the warehouse management system may generate information about the type and quantity of the products stacked on the pallet. The information about the type and quantity of products generated may provide a means to improve the accuracy of product storage and release through double-checking with the information about the type/quantity of products written when the products are stored and released.

According to the above-described configuration, the server 100 may perform at least one operation for controlling the plurality of event notification units based on the product information received from the user terminal 200. As a result, users may conveniently recognize the location where the product is stored.

Hereinafter, the following example describes an implementation of the warehouse management system.

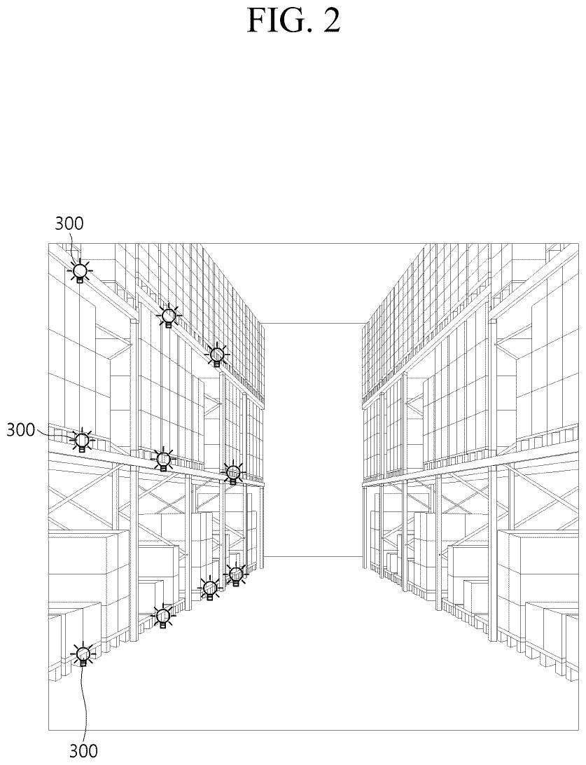

FIG. 2 is a diagram illustrating an example of a warehouse management system according to some exemplary embodiments of the disclosure.

Referring to FIG. 2, the warehouse management system may include a plurality of event notification units 300. The plurality of event notification units 300 may be provided on the pallet on which the products are stacked, on a structure above the location where the products are stacked, on the ceiling of the location where the products are stacked, or on the floor of the location where the products are stacked.

When the control unit 110 receives product information for a first product from the user terminal 200, the control unit 110 may determine a first location in the warehouse where the first product is stored. The control unit 110 may determine a first event notification unit present at the location corresponding to the first location. The control unit 110 may control the plurality of event notification units 300 such that the determined first event notification unit emits light.

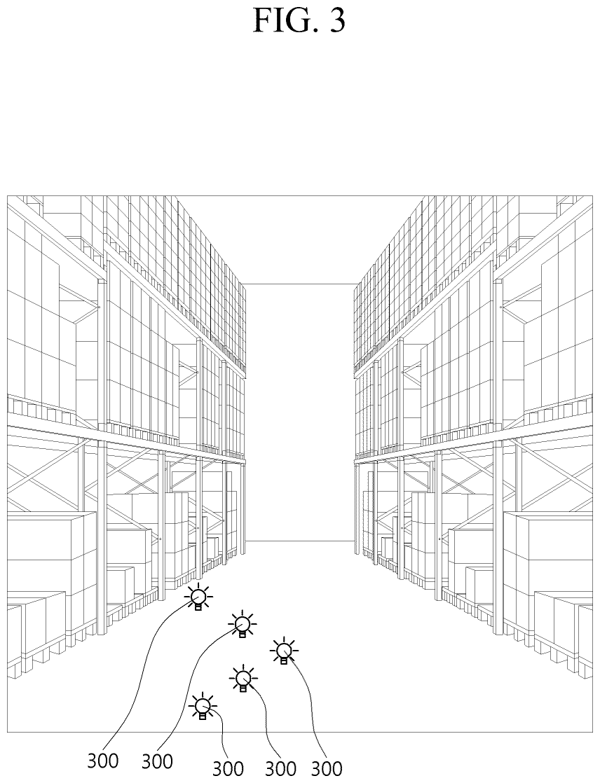

FIG. 3 is a diagram to illustrate an example of a warehouse management system according to some exemplary embodiments of the disclosure.

Referring to FIG. 3, the warehouse management system may include a plurality of event notification units 300.

When the control unit 110 receives product information for a fourth product from the user terminal 200, the control unit 110 may determine a fourth location in the warehouse where the fourth product is stored. The control unit 110 may determine at least one fourth event notification unit present along a route from the location of the user terminal 200 to the fourth location where the fourth product is stored. The control unit 110 may control the plurality of event notification units 300 such that the determined at least one fourth event notification unit emits light.

According to FIGS. 2 and 3, the warehouse management system may control the event notification unit present at the location where the products are stacked to emit light, or may control the plurality of event notification units 300 such that the plurality of event notification units 300 present along the route to a location where the products are stacked emits light. Traditionally, when a user checks a location of a product with an RFID device, only zone information, such as A-1 and E-1, is provided to the RFID device. However, in vast warehouses built to store the large amount of products, it may be difficult for users to find the desired product based on zone information alone. On the other hand, the warehouse management system according to the present disclosure may control an event notification unit present at a location where the products are stacked to emit light, or may control the plurality of event notification units 300 such that the plurality of event notification units 300 present along a route to a location where the products are stacked emits light. As a result, users are capable of finding the desired products at their convenience.

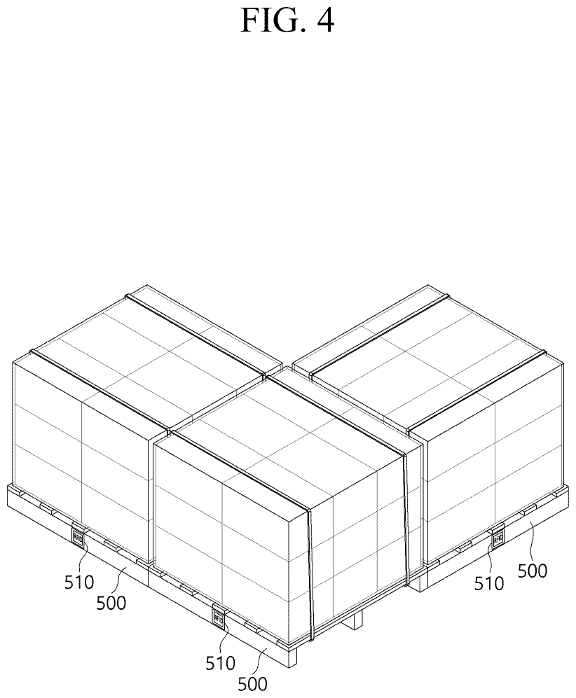

FIG. 4 is a drawing illustrating an example of a pallet according to some exemplary embodiments of the present disclosure.

Referring to FIG. 4, the pallet 500 may have at least one surface disposed externally. For example, at least one surface of the pallet 500 may be disposed externally to allow a user to perform RFID tagging through the user terminal 200. The products placed on the pallet 500 may be arranged so that barcodes or RFID-responding chips disposed on the products face outward, thereby facilitating RFID tagging through the outer circumference. This may provide a means for recognizing related information in a single step through RFID tagging of the external surface of the pallet 500 when the products are stored and released.

On the other hand, RFID is a technology that uses radio waves to recognize information at close range. Accordingly, a chip for RFID tagging may be provided on the interior of the pallet 500. However, the chip for RFID tagging is provided on the interior, so that it may be difficult for the user to recognize where the chip for RFID tagging is located. Thus, the pallet 500 may have at least one surface disposed on the exterior portion where a chip for RFID tagging is present, and a location indicator 510 may be attached to the exterior portion.

According to the exemplary embodiment, the pallet 500 may include a sensing unit, a pallet communication unit, and a pallet control unit.

The sensing unit may sense the weight of at least one product stacked on the pallet.

When a change in the weight sensed by the sensing unit is detected, the pallet control unit may transmit information about the weight change to the server 100 through the pallet communication unit.

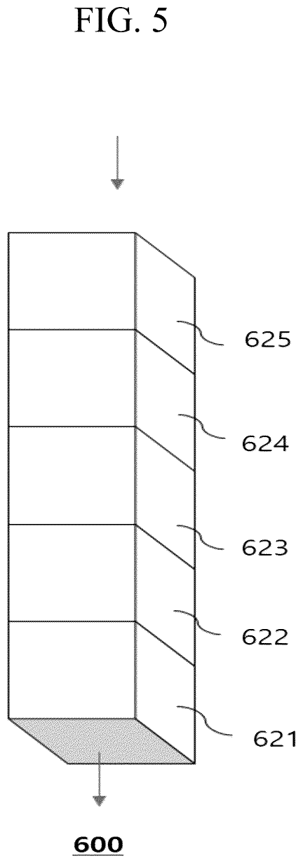

FIG. 5 is a diagram illustrating an example of distribution of individual products in the warehouse management system according to some exemplary embodiments of the present disclosure.

Referring now to FIG. 5, an individual product distribution system 600 may be disposed in a warehouse area corresponding to each of the products in the warehouse system illustrated in FIG. 2. For example, a first distribution system for distributing a first pharmaceutical may be disposed in a first area and the first pharmaceutical may be stored, and a second distribution system for distributing a second pharmaceutical may be disposed in a second area distinct from the first area and the second pharmaceutical may be stored. While pharmaceuticals have been described as examples of stored products, it will be understood by those of ordinary skill in the art that the stored product is not limited thereto, and the present invention may be applied to any product.

According to one exemplary embodiment, the individual product distribution system 600 may include storage areas 621, 622, 623, 624, and 625 where products are stored, respectively. Products stored in each of the storage areas 621, 622, 623, 624, and 625 may be brought in the direction of the top arrow and be brought out in the direction of the bottom arrow. Accordingly, for the products corresponding to the individual product distribution system 600, a product stored in the storage area 621 may be first released, and next, the product stored in the storage area 622 may be released, followed by the product stored in the storage area 623. The products may be sequentially moved in the manner that when the product stored in the storage area 621 are released, the product stored in the storage area 622 may be moved to the storage area 621, and the product stored in the storage area 623 may be moved to the storage area 622.

In general, for the products stored in the individual product distribution system 600, the product stored in the storage area 621 may be the oldest product brought in, and the product stored in the storage area 625 may be the product most recently brought in.

In accordance with the exemplary embodiment, the individual product distribution system 600 may further provide a function of switching storage areas based on an expiration date of the product. For example, in a situation where products with earlier expiration dates are stored in order from the storage area 621 to the storage area 624, when an expiration date of a product newly brought in the storage area 625 is an intermediate date of the expiration date of the product stored in the storage area 623 and the expiration date of the product stored in the storage area 622, the individual product distribution system 600 may provide a means for automatically placing the product newly brought in the storage area 625 into the storage area 623, and automatically moving products already placed in the storage area 623 and the storage area 624 to the storage area 624 and the storage area 625, respectively.

This may provide a means for supporting product release for each expiration date and supporting smoother product release. In particular, such a system may be effectively applied to the distribution of pharmaceuticals where adherence to the expiration date is critical.

The warehouse management system according to the exemplary embodiment may interwork with an Automated Guided Vehicle (AGV), autonomous robots, and the like to support the distribution of products. More specifically, the warehouse management system may provide location information of products designated to be stored/released through the user terminal to the AGV or the autonomous robot to support automatic product distribution.

The description of the presented exemplary embodiments is provided so as for those skilled in the art to use or carry out the present disclosure. Various modifications of the exemplary embodiments may be apparent to those skilled in the art, and general principles defined herein may be applied to other exemplary embodiments without departing from the scope of the present disclosure. Accordingly, the present disclosure is not limited to the exemplary embodiments suggested herein, and shall be interpreted within the broadest meaning range consistent to the principles and new characteristics presented herein.

What is claimed is:

1. A pharmaceutical stock warehouse management system, comprising:
a plurality of event notification units;
a user terminal for recognizing product information under control of a user; and
a server performing at least one operation for controlling the plurality of event notification units based on the product information received from the user terminal.

2. The warehouse management system of claim 1, wherein the at least one operation includes at least one of:
a first operation of controlling the plurality of event notification units to cause a first event notification unit present at a first location where a product corresponding to the product information is stored to emit light;
a second operation of controlling the plurality of event notification units to cause a second event notification unit present at a second location where a product corresponding to the product information is stored to emit a sound; and
a third operation of controlling the plurality of event notification units to cause a third event notification unit present at a third location where a product corresponding to the product information is stored to emit light and a sound.

3. The warehouse management system of claim 1, wherein the server receives location information indicative of a location of the user terminal in conjunction with reception of the product information from the user terminal, and
the at least one operation includes at least one of:
a fourth operation of controlling, based on the location information of the user terminal, at least one fourth event notification unit present along a route from the location of the user terminal to a fourth location where a product corresponding to the product information are stored to emit light; and
a fifth operation of controlling, based on the location information of the user terminal, the plurality of event notification units such that a sound emitted by a fifth event notification unit present at a fifth location becomes louder as the location of the user terminal approaches the fifth location where a product corresponding to the product information are stored.

4. The warehouse management system of claim 1, wherein the server receives location information indicative of a location of the user terminal in conjunction with reception of the product information from the user terminal, and,
the at least one operation includes a sixth operation of providing, based on the location information of the user terminal, a route to the user terminal such that a route from a location of the user terminal to a sixth location at which a product corresponding to the product information is stored is displayed on the user terminal.

5. The warehouse management system of claim 1, further comprising:
a pallet on which at least one product is stacked,
wherein the pallet includes:
a sensing unit for sensing weight of the at least one product; and
a pallet control unit for, when a change in weight sensed by the sensing unit is detected, transmitting information about the change in weight to the server through a pallet communication unit.
